(19) United States
(12) Patent Application Publication
(10) Pub. No.: US 2009/0228876 A1
(43) Pub. Date: Sep. 10, 2009

(54) METHOD AND APPARATUS FOR PROCESSING MULTI-MEDIA SCRIPT

(75) Inventors: Ningjiang Chen, Shanghai (CN); Xin Chen, Shanghai (CN); Yongqin Zeng, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,673

(22) PCT Filed: Dec. 15, 2004
(86) PCT No.: PCT/IB04/52811

§ 371 Date: Jun. 21, 2006

(30) Foreign Application Priority Data
Dec. 25, 2003 (CN) 200310110283.7

(51) Int. Cl. G06F 9/44

(52) U.S. Cl. 717/168

(57) ABSTRACT

The present invention provides method and apparatus for dynamically updating and processing the multimedia script (510) for network servers (110). By replacing a responding software module which responds to an activating instruction (m, m1, m2, . . . ) with the time-based responding software module (520, 530), the playing of the specific multimedia element no longer depends on the activating instructions (m, m1, m2) frequently inserted by program editors to be activated, but is automatically activated based on the specific time. The method and the device provided by the present invention reduces the redundant information of a multimedia playing system, avoids the situation that the corresponding multimedia element can not be displayed because the user terminal (130) misses receiving the activating instruction (m, m1, m2, . . . ).

### BACKGROUND ART

The present invention relates to multimedia technology, and in particular to a method and apparatus for processing multimedia scripts.

Digital multimedia broadcasting technology is applied more and more extensively in the field of information broadcasting (for example, it is applied to tele-education) and gradually becomes prevalent. In digital multimedia broadcasting technology, multimedia scripts are used to control each multimedia element (for example, audio/video files in various formats, etc.) to be played according to certain time and position relations so as to achieve the effect of multimedia synchronous playing.

FIG. 1 is schematic diagram of a traditional multimedia playing system. As shown in this Figure, network server 110 provides various information to a plurality of user terminals 130 via network 120, network server 110 has primary program, auxiliary program, multimedia scripts, etc. stored therein. The primary program can be audio/video program stream that is recorded in real-time, such as the teaching videorecord of tele-education, it can also be the program that has already been stored in the network server or other addresses. The auxiliary program is the program other than the primary program, for example, the picture, explanatory words, background materials that are played together with the teaching program, they can make the played primary program more wonderful and vivid.

The programs to be played during the process of playing program are listed explicitly in multimedia scripts, however, where a real-time program is concerned, usually the relative time relations among all the programs are not determined, the program editors are needed to determine these relations via activating instructions during program playing (for example, inserting activating signals, media marks, etc. into the primary program stream). Some functional modules in the multimedia scripts can activate the corresponding multimedia elements according to the received activating instructions so that these multimedia elements are played at the user terminal, for instance, an auxiliary program related to the first chapter is activated when the teacher explains the first chapter, these functional modules are named as responding software modules in this disclosure.

When starting playing the program, user terminal 130 links network server 110 via network 120 and downloads multimedia scripts. Under the control of the scripts, user terminal 130 plays the program. Normally, under the control of scripts, user terminal 130 can download the audio/video primary program (i.e. the primary program stream) whilst playing it in real-time.

During playing the primary program, if a certain auxiliary program needs to be played together with the primary program, the program editor inserts an activating instruction corresponding to the auxiliary program into the primary program stream of network server 110. If a picture of equation needs to be displayed when the teacher explains the second chapter in tele-education, the editor may insert an activating instruction corresponding to this picture. The activating instruction will be downloaded to the user terminal along with the primary program stream.

During playing the downloaded primary program at user terminal 130, if it is monitored that there is an activating instruction in the primary program stream, the playing means at the user terminal 130 transmits this activating instruction to the downloaded scripts. Corresponding responding software modules in the downloaded scripts will respond to this activating instruction to activate corresponding auxiliary program (e.g. equation picture) so that the auxiliary program is played at the user terminal 130.

However, some user terminals 130 start linking the network server and downloading scripts after the program is played, although the scripts downloaded by these user terminals are identical with those at other user terminals 130, the user terminals cannot play the multimedia elements to which these activating instructions correspond due to missing of some activating instructions. For example, in tele-education, a teaching auxiliary picture can only be played after being activated by an activating instruction m, however, before the user terminal A links the network server 110, the activating instruction m has already been transmitted, so the user terminal A cannot receive an activating instruction m, as a result the teaching picture cannot be played at the user terminal A, whereas other user terminals can play the teaching picture because they receive the activating instruction m, thus rendering the latecomers unable to display the teaching picture that has already been activated and shall be still displayed on their displays like those students that come early.

In order to enable all the user terminals 130 to play the same content at the same time as possible as they can, a general way is that the editor frequently inserts an activating instruction corresponding to a certain multimedia element into the primary program stream so that the user terminal 130 has more chances of receiving the activating instruction.

FIG. 2 is a schematic diagram showing the editor frequently inserts an activating instruction into the primary program stream. As shown in this figure, block 210 is a primary program stream, m1, m2, m3 and m4 are activating instructions inserted into the primary program stream that correspond to different multimedia elements respectively. The program editor frequently inserts an activating instruction into the primary program stream of network server to increase the chance of receiving the activating instructions by the user terminal.

The way shown in FIG. 2 still has the following problems: first, the activating instruction must be inserted repeatedly and frequently, which leads to the result that the program editor is overloaded with details and the system needs to process a lot of redundant information; second, even if an activating instruction is frequently inserted into the program stream, it is still unable to avoid that some user terminals cannot display certain programs. For example, as shown in FIG. 2, if user terminal A links network server 110 at time Tx, it already misses receiving the activating instruction m1 transmitted by the network server 110 at time Tm1-7, and it does not await an activating instruction m1 inserted at time Tm1-8, then during time T from Tx to Tm1-8, the user terminal A cannot display the multimedia elements to which the activating instruction m1 corresponds; third, inserting the same activating instruction for many times will activate corresponding multimedia elements repeatedly, which may destroy the synchronous relation between this multimedia element and other multimedia elements. Therefore, the files like an activated multimedia element table or the received activating instruction table must be established at the user terminal to prevent corresponding multimedia elements from being repeatedly activated.

Therefore, it needs to provide a method and apparatus that not only prevent the contents displayed at the user terminal from influence of the time of linking the network server and but also reduce the redundant information of multimedia playing system.

### Contents of the Invention

The prevent invention provides a method and means for processing multimedia scripts to overcome the disadvantages in the prior art.

The invention provides a method for processing multimedia scripts, said scripts include at least one initial responding software module for activating a corresponding multimedia element, said processing method comprising the steps of: receiving an activating instruction which corresponds to said initial responding software module; acquiring the specific parameters of said activating instruction; and updating said initial responding software module according to said specific parameters, so that the updated responding software module can activate said multimedia element based on the acquired specific parameters.

The scripts further provided by the invention include at least one initial responding software module which is used for activating a corresponding multimedia element, said means comprising: a receiving means for receiving an activating instruction, said activating instruction corresponds to said initial responding software module; an acquiring means for acquiring the specific parameters of said activating instruction; and an updating means for updating said initial responding software module according to said specific parameters, so that the updated responding software module can activate said multimedia element according to the acquired specific parameters.

Through the method and means as provided by the invention, the activating instruction corresponding to specific multimedia element only need to be inserted once by the program editor so as to prevent the contents displayed at the user terminal from the influence of the time of linking the network server and reduce the redundant information of the system.

Through the following description of the invention made with reference to the drawings and the contents of the claims, other objects of the invention and achievements become obvious, then a comprehensive understanding of the invention can be obtained.

### DESCRIPTION OF FIGURES

Through embodiments, further detailed explanation of the invention is made with reference to the drawings.

FIG. 1 is a schematic diagram of a traditional multimedia playing system;

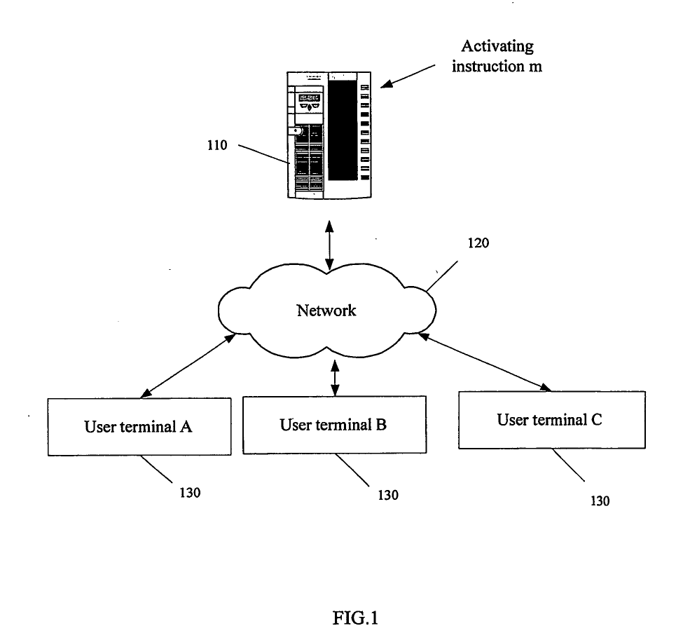

FIG. 2 is a schematic diagram showing the editor inserts an activating instruction in the primary program stream at the network server terminal frequently;

FIG. 3 is a flowchart of a method for processing multimedia scripts in the network server according to an embodiment of the invention;

FIG. 4 is a schematic diagram of inserting the activating instruction into a program stream according to an embodiment of the invention;

FIG. 5 is a figure according to an embodiment of processing scripts in the invention;

FIG. 6 is a figure showing the means 600 for processing scripts in the network server according to an embodiment of the invention;

In the above figures, the same sign represents the same, similar or corresponding feature or function.

### MODE OF CARRYING OUT THE INVENTION

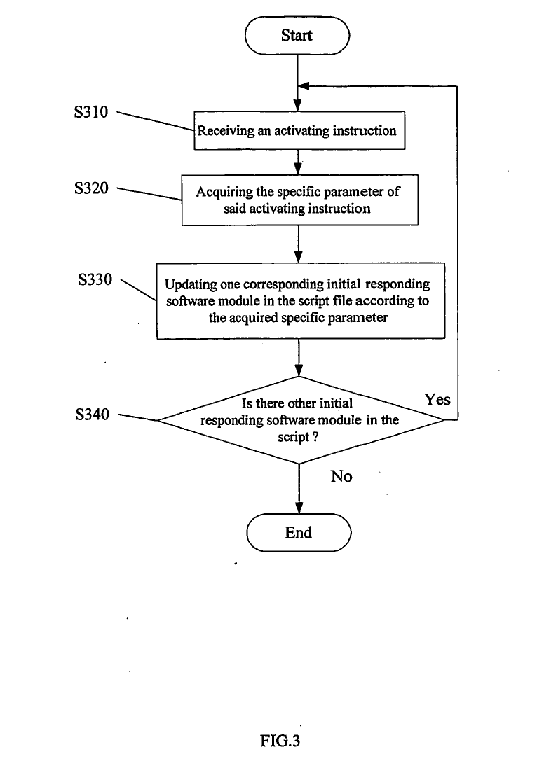

FIG. 3 is a flowchart of a method for processing multimedia scripts in the network server according to an embodiment of the invention. A script is stored in the network server, this script can be identical with the script in traditional technology, such as the XML based script (including SMIL script and so on). The script comprises at least one initial responding software module. If the script is downloaded to the user terminal, the initial responding software module is used to activate a corresponding program to be played in response to the external activating instruction so that the program is played at the user terminal.

The program that needs to be played during program playing is so determined through respective initial responding software modules of the script in the network server, however, the playing time relations among all the programs have not been determined yet, it still needs the program editor to control during the process of playing program via an activating instruction. While playing the program, the user terminal downloads the script and control the playing of each program with the aid of the script.

During the process of playing multimedia program, the network server receives an activating instruction (step S310) that is inserted by the program editor into the primary program stream, this activating instruction corresponds to a program to be played.

Then, the network server acquires a specific parameter of the activating instruction (step S320), the specific parameter comprises time parameters such as the relative time at which said activating instruction is received in the case of taking the time of starting playing the program as the reference time point. According to the invention, the activating instruction has two functions: one, together with the primary program stream, the activating instruction will be downloaded to the user terminal which is already linked to the network server, so that the corresponding program to be played is activated by the responding software means corresponding to the script that has already been downloaded at the user terminal; second, the specific parameter of the activating instruction will be used for processing the script at the network server terminal.

Next, the network server updates, according to a specific parameter of the acquired activating instruction (for example, the relative time of receiving the activating instruction, etc.) a corresponding initial responding software module of the script (step S330), so as to activate corresponding multimedia elements based on the acquired specific parameter. Specifically, the initial responding software module in the script responds to the activating instruction inserted into the primary program stream, that is, it is an external activating instruction that is used to initiate the initial responding software module in the script. The updated responding software module makes a response based on a specific time (e.g. the time of receiving the activating instruction), that is, the updated corresponding responding software module is initiated based on specific time. When the time comes or expires, corresponding multimedia elements will be automatically activated.

During the process of playing program, steps S310 and S330 will be repeated to update the script if there are other initial responding modules (step 340).

After updating the script, if there is a new user terminal linked to the network server, the network server will provide the most recently updated script to the user terminal, then the user terminal will play the program under the control of the most recently updated script, comprising playing the primary program and the auxiliary program that is activated based on the specific time. In this way, the user terminal that subsequently links the network server will automatically display the multimedia element that has already been activated previously.

According to the invention, generally the program editor do not need to insert again a repetitive activating instruction after inserting an activating instruction, however, a User Datagram Protocol (UDP) that is commonly used for broadcasting program cannot guarantee that the information can be accurately delivered to the user terminal. Therefore, in order to ensure the user terminal can receive the activating instruction, an activating instruction can be inserted twice.

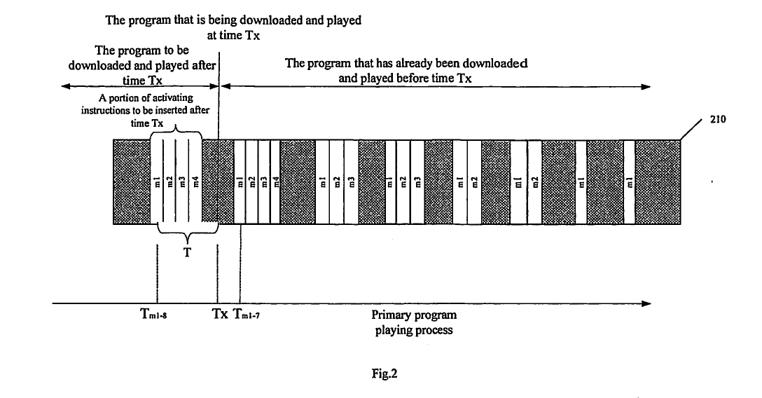

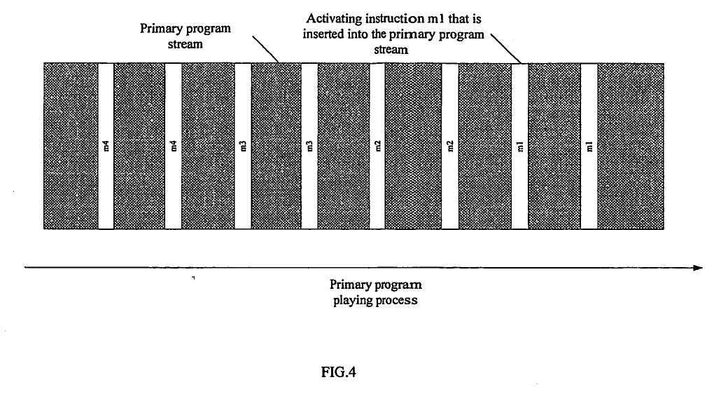

FIG. 4 is a schematic diagram of inserting an activating instruction into a program stream according to an embodiment of the invention. As shown in FIG. 4, activating instructions m1, m2, m3 and m4 are inserted twice respectively, in comparison with FIG. 2, the times of inserting the activating instruction are reduced greatly so that the program editor is less burdened and the redundant information of the multimedia playing system is reduced.

According to the invention, if a corresponding activating instruction is inserted only once for the same multimedia element, it does not need to create the files like the activated multimedia element table or the received activating instruction table at the user terminal. If the same corresponding activating instruction is inserted twice for the same multimedia element, then the user terminal can create the files like an activating instruction table because the script downloaded at the user terminal may possibly contain the initial responding software module that has not been updated yet, and because if the user terminal receives the identical activating instruction twice, then the synchronization relation among a plurality of multimedia elements may possibly be destroyed. However, said file is different from the activated multimedia element table or the received activating instruction in the traditional technology, only the activating instruction that is received for the first time is listed in said file, the same activating instruction that is received for the second time is not executed, moreover, the activating instruction that is received for the first time is deleted from said file when the same activating instruction is received for the second time. Therefore, the redundant information of multimedia playing system is further reduced.

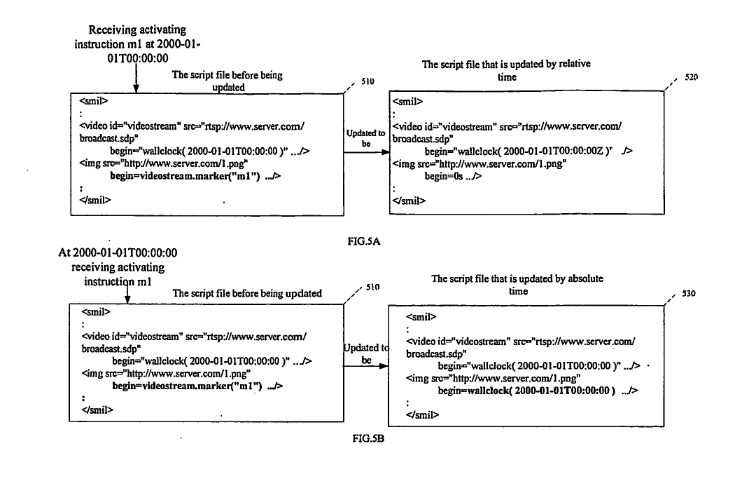

FIG. 5A and FIG. 5B are figures according to an embodiment of processing scripts at the network server terminal in the invention. The script 510 prior to updating is stored in the network server, and if the user terminal downloads by using the script 510 prior to updating, then multimedia element 1.png can be activated and played at the user terminal according to the received activating instruction ml.

When the network server receives an activating instruction m1 inserted by the program editor at the time 00:00:00 on Jan. 1, 2002, the network server will update corresponding initial responding software module in the script according to the time of receiving the activating instruction m1. FIG. 5A and FIG. 5B list scripts 520 and 530 that are updated using two different time parameters respectively.

In FIG. 5A, the time of receiving the activating instruction m1 is relative to the time of starting playing the primary program by a zero second (the unit is S), the relative time zero second is used to update corresponding initial responding software module in the script 510 at the network server terminal. In FIG. 5B, the absolute time of receiving the activating instruction m1 “wallclock (2000-01-01T00:00:00)” can be used to update the corresponding initial software module at the network server terminal.

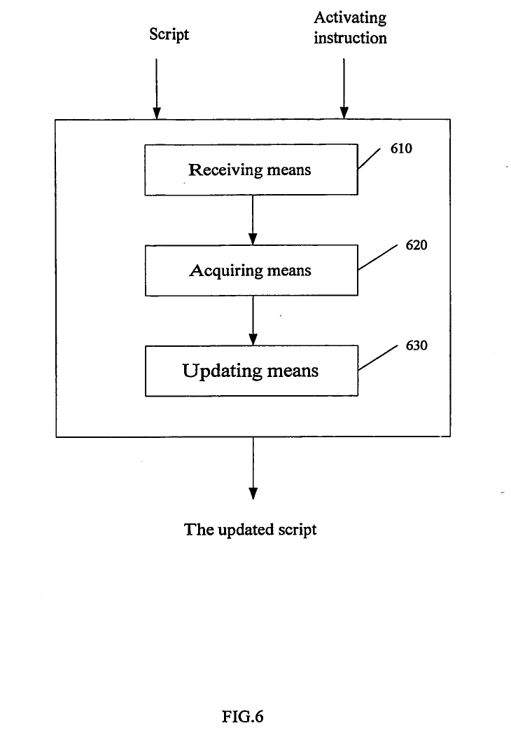

FIG. 6 is a figure showing the means 600 for processing scripts in the network server according to an embodiment of the invention. Means 600 includes a receiving means 610 for receiving the activating instruction inserted into the primary program stream of the network server by the program editor, said activating instruction corresponds to specific multimedia elements to be played.

The activating instruction together with the primary program stream will be downloaded to the user terminal that has already linked the network server before receiving the activating instruction. The activating instruction is used to make the corresponding initial responding software module in the script downloaded at the user terminal activate the corresponding multimedia elements to be played; on the other hand, the activating instruction will be used to process the script at the network server terminal by the network server.

Means 600 further includes an acquiring means 620 for acquiring specific parameters of an activating instruction, for example, the relative time of receiving the activating instruction, etc. The time of receiving the activating instruction can reflect the time synchronizing relation between the multimedia elements corresponding to the activating instruction and other multimedia elements (for example, primary program).

Means 600 further comprises a updating means 630 for, according to specific parameters of the activating instruction acquired by the acquiring means 620, update the corresponding initial responding software module in the script at the network server terminal, so that the updated responding software module can activate the corresponding multimedia elements based on the specific time. After the user terminal downloads the processed script from the network server, under the control of the script, the multimedia elements that have already been activated and are still displayed before the user terminal links the network server will be automatically played at the user terminal, it does not need to await the activation of the activating instruction.

Through the method and apparatus provided by the invention, the network server dynamically updates the multimedia script so as to simplify the operation of the multimedia playing system and guarantee the playing effect of the user terminal.

Although the present invention is described with particular embodiments, apparently various alternatives, modifications and changes that are made according to the contents as mentioned above are obvious to those skilled in the ar. Therefore, all these alternatives, modifications and changes shall come within the spirit and scope of the appended claims.

What is claimed is:

1. A method for processing the multimedia script, wherein the multimedia script includes at least one initial responding software module, which is used for activating a corresponding multimedia element, comprising the steps of:
(a) receiving an activating instruction which corresponds to said initial responding software module;
(b) acquiring a specific parameter of said activating instruction; and
(c) updating said initial responding software module according to said specific parameter in order that the updated responding software module can activate said multimedia element based on the specific parameter acquired.

2. The method according to claim 1, wherein said activating instruction includes a multimedia mark.

3. The method according to claim 1, wherein said specific parameter includes the specific time parameter.

4. The method according to claim 3, wherein said specific time parameter includes the time when said activating instruction is received.

5. The method according to claim 4, wherein said time when said activating instruction is received includes the relative time when said activating instruction is received.

6. The method according to claim 1, wherein step (c) includes replacing said initial responding software module with the corresponding responding software module which responds to said specific parameter.

7. The method according to claim 6, wherein said specific parameter includes the time when said activating instruction is received.

8. The method according to claim 6, wherein said specific parameter includes the relative when said activating instruction is received.

9. An apparatus for processing the multimedia script, wherein the multimedia script includes at least one initial responding software module which is used for activating a corresponding multimedia element, comprising:
receiving means for receiving an activating instruction, said activating instruction corresponding to said initial responding software module;
acquiring means for acquiring the specific parameter of said activating instruction; and
updating means for updating said initial responding software module according to said specific parameter, so that the updated responding software module can activate said multimedia element according to the specific parameter acquired.

10. The apparatus according to claim 9, wherein said specific parameter include the specific time parameter.

11. The apparatus according to claim 10, wherein said specific time parameter includes the when said activating instruction is received.

12. The apparatus according to claim 9, wherein said updating of said initial responding software module according to said specific parameter includes replacing said initial responding software module with the corresponding responding software module which responds to said specific parameter.

13. A server, in which a script is stored, wherein said script includes at least one initial responding software module which is used for activating a corresponding multimedia element, comprising:
means for processing the multimedia script file, comprising:
receiving means for receiving an activating instruction which corresponds to said initial responding software;
acquiring means for acquiring the specific parameter of said activating instruction; and
updating means for updating said initial responding software module according to said specific parameter, so that the updated responding software module can activate said multimedia element according to the acquired specific parameter; and
information transmitting means for transmitting the activating instructions and the script files to the user terminals connected to said server.

14. A server according to claim 13, wherein said specific parameter includes a specific time parameter.

15. A server according to claim 14, wherein said specific time parameter includes the when said activating instruction is received.
